(19) United States
(12) Patent Application Publication
(10) Pub. No.: US 2025/0277726 A1
(43) Pub. Date: Sep. 4, 2025

(54) SPECIAL FIXTURES FOR TENSILE TESTING THE UNIVERSAL SAFETY SEAT BELT BUCKLE AT DIFFERENT ORIENTATIONS

(71) Applicant: Ibrahim M. ALARIFI, Majmaah (SA)

(72) Inventors: Ibrahim M. ALARIFI, Majmaah (SA); Tarek Mohamed Ahmed Ali EL-BAGORY, Cairo (EG)

(21) Appl. No.: 19/210,581

(22) Filed: May 16, 2025

(51) Int. Cl. G01N 3/04; G01N 3/08

(52) U.S. Cl. CPC G01N 3/04; G01N 3/08; G01N 2203/0005; G01N 2203/0017; G01N 2203/0435

(57) ABSTRACT

The present disclosure relates to fixtures for tensile testing of universal safety seat belt buckles at different orientations. The proposed fixtures address the limitations of traditional testing methods by simulating a wide range of loading angles and orientations while ensuring secure fixation of the seat belt buckle during mechanical testing. The special fixtures simulate seventeen different loading angles, ranging from 10 to 90 degrees with 5-degree increments, allowing for studying the most common and critical loading scenarios encountered by seat belt buckles in real-world situations. The fixtures incorporate two connection pins and four pairs of cylinder discs with different loading angles to prevent slippage and ensure accurate testing. By accurately replicating diverse range of loading angles and orientations experienced by seat belt buckles, the proposed fixtures enable manufacturers to understand the buckle's performance under various scenarios.

### FIELD OF THE INVENTION

The present disclosure relates to automotive safety testing and, more specifically, to a fixture system designed for tensile testing of universal safety seat belt buckles. This system is intended to simulate various real-world loading conditions that seat belt buckles may encounter during vehicle collisions or sudden deceleration. The invention provides a reliable and versatile testing platform to evaluate the performance, strength, and durability of safety seat belt buckles, ensuring they meet stringent industry safety standards and regulations. The special safety fixtures include seventeen loading angles incrementing from 10 to 90 degrees by 5 degrees to investigate the most actual seal belt buckle cases.

### BACKGROUND OF THE INVENTION

The universal seat belt buckle is crucial in modern automotive safety systems to secure passengers during collisions or sudden stops. The importance of these buckles cannot be overstated, as they play a vital role in preventing or minimizing injuries and saving lives. However, ensuring the quality and reliability of these safety-critical components poses significant challenges for manufacturers.

One of the primary concerns in producing universal safety seat belt buckles is the accurate simulation of real-world loading conditions during mechanical testing and quality assurance processes. Improper testing methods or inadequate simulation of actual loads can lead to inaccurate assessments of a buckle's performance, potentially compromising passenger safety in the event of an accident.

Traditionally, manufacturers have relied on fixed testing fixtures to evaluate the performance of seat belt buckles under various loading scenarios. However, these fixtures often fail to accurately replicate the diverse range of loading angles and orientations that a buckle may encounter in real-world situations. This limitation can result in incomplete or misleading test results, potentially overlooking critical failure modes or weaknesses in the buckle design.

Furthermore, the issue of slippage during testing presents another significant challenge. Suppose the testing fixtures fail to securely hold the seat belt buckle during loading. In that case, the results may be skewed, leading to inaccurate assessments of the product's performance and potential safety risks.

Innovative fixtures that can simulate a wide range of loading angles and orientations while securely holding the buckle during testing are urgently needed to address these challenges and enhance the safety and reliability of universal safety seat belt buckles. By accurately replicating real-world conditions, manufacturers can comprehensively understand a buckle's performance under various scenarios, enabling them to identify and address potential weaknesses or failure modes more effectively.

Given the discussion, an invention that aims to solve these issues by introducing specialized testing fixtures designed to simulate a wide range of loading angles and orientations while ensuring secure fixation of the seat belt buckle during mechanical testing is needed. The proposed fixtures address the limitations of traditional testing methods, providing manufacturers with a more accurate and reliable means of evaluating the performance and safety of their universal safety seat belt buckles.

### SUMMARY OF THE INVENTION

The present disclosure relates to special fixtures for tensile testing of the universal safety seat belt buckle at different orientations. The present invention particularly relates to specialized testing fixtures designed for evaluating the performance and safety of universal safety seat belt buckles under various loading conditions. The proposed fixtures address the limitations of traditional testing methods by simulating a wide range of loading angles and orientations while ensuring secure fixation of the seat belt buckle during mechanical testing. The proposed special fixtures include seventeen loading angles to study the most actual seat belt buckle cases and secure fixations.

The special fixtures can simulate seventeen different loading angles, ranging from 10 to 90 degrees, with increments of 5 degrees. This comprehensive range of angles allows for studying the most common and critical loading scenarios encountered by seat belt buckles in real-world situations. Furthermore, the proposed special fixtures incorporate two connection pins and four pairs of cylinder discs with different loading angles to prevent slippage and ensure accurate testing. These components work together to securely hold the seat belt buckle in place during mechanical testing, eliminating the risk of inaccurate results due to slippage or improper positioning. The proposed special fixtures aim to provide an accurate simulation of loading conditions, wherein by accurately replicating the diverse range of loading angles and orientations experienced by seat belt buckles, the proposed special fixtures enable manufacturers to gain a comprehensive understanding of the buckle's performance under various scenarios. This information is crucial for identifying and addressing potential weaknesses or failure modes, ultimately enhancing the safety and reliability of the final product.

The specialized testing fixtures described in this invention significantly improve traditional testing methods, providing manufacturers with a more accurate and reliable means of evaluating the performance and safety of universal safety seat belt buckles. By simulating real-world loading conditions and ensuring secure fixation during testing, this invention addresses critical challenges in the quality assurance process, contributing to the development of safer and more reliable automotive safety systems.

In an embodiment, a fixture system for tensile testing of a universal safety seat belt buckle is disclosed. The system includes a base plate adapted to mount on a fixture securely, comprising recesses configured to receive and position a plurality of cylinder discs at predetermined loading angles.

The system further includes a plurality of connection pins adapted to link the fixture with a universal tensile testing machine and securely hold the seat belt buckle in place during testing. The connection pins extend through the plurality of cylinder discs and have a threaded portion for secure attachment.

The system further includes a plurality of cylinder discs segmented into pairs, each pair having angled surfaces on an outer periphery thereof, the angled surfaces configured to apply the predetermined loading angles to the seat belt buckle when the cylinder discs are positioned in the recesses of the base plate, wherein the plurality of cylinder discs comprise at least three pairs to accommodate a wide range of loading angles, wherein the plurality of cylinder discs are selectively positional around the connection pins to simulate various loading angles on the seat belt buckle.

An objective of the present invention is to provide special fixtures for tensile testing of the universal safety seat belt buckle at different orientations.

Another object of the present invention is to evaluate the performance and safety of universal safety seat belt buckles under various loading conditions.

Another objective of the present invention is to simulate a wide range of loading angles, ranging from 10 to 90 degrees, with increments of 5 degrees, to accurately replicate real-world scenarios encountered by seat belt buckles.

Another objective of the present invention is to ensure secure fixation of the seat belt buckle during mechanical testing, preventing slippage and inaccurate results.

Another objective of the present invention is to incorporate two connection pins and four pairs of cylinder discs with different loading angles, which enable the seat belt buckle to be securely held during testing.

Another objective of the present invention is to provide manufacturers with a comprehensive understanding of the seat belt buckle's performance under diverse loading conditions, allowing for the identification and mitigation of potential weaknesses or failure modes.

Yet, another objective of the present invention is to contribute to developing safer and more reliable automotive safety systems by improving the quality assurance process for universal safety seat belt buckles.

To further clarify the advantages and features of the present disclosure, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained in detail in the accompanying drawings.

### BRIEF DESCRIPTION OF FIGURES

These and other features, aspects, and advantages of the present disclosure will become better understood when the following detailed description is read concerning the accompanying drawings in which like characters represent like parts throughout the drawings, wherein:

FIG. 1 illustrates an elevation view of the special fixtures by an embodiment of the present disclosure;

FIG. 2 illustrates a right-side view of the special fixtures by an embodiment of the present disclosure;

FIG. 3 illustrates a right-sectional side view of the special fixtures in accordance with an embodiment of the present disclosure;

FIG. 4 illustrates a left-side view of the special fixtures in accordance with an embodiment of the present disclosure;

FIG. 5 illustrates a top view of the special fixtures in accordance with an embodiment of the present disclosure;

FIG. 6 illustrates a bottom view of the special fixtures in accordance with an embodiment of the present disclosure;

FIG. 7 illustrates a section button view of the special fixtures in accordance with an embodiment of the present disclosure;

FIG. 8 illustrates a perspective view of the special fixtures in accordance with an embodiment of the present disclosure;

FIG. 9 illustrates a block diagram of a fixture system for tensile testing of a universal safety seat belt buckle in accordance with an embodiment of the present disclosure;

FIG. 10 illustrates a graph depicting a tensile testing performed according to the ASTM D 638 standard 10-degree angle in accordance with an embodiment of the present disclosure;

FIG. 11 illustrates a graph depicting a tensile testing performed according to the ASTM D 638 standard 50-degree angle in accordance with an embodiment of the present disclosure;

FIG. 12 illustrates a graph depicting tensile testing performed according to the ASTM D 638 standard 90-degree angle in accordance with an embodiment of the present disclosure.

Further, skilled artisans will appreciate that those elements in the drawings are illustrated for simplicity and may not have necessarily been drawn to scale. For example, the flow charts illustrate the method in terms of the most prominent steps involved in improving understanding of aspects of the present disclosure. Furthermore, in terms of the device's construction, conventional symbols may have represented one or more components in the drawings. The drawings may show only those specific details pertinent to understanding the embodiments of the present disclosure so as not to obscure the drawings with details readily apparent to those of ordinary skill in the art having the benefit of the description herein.

### DETAILED DESCRIPTION

To promote an understanding of the principles of the invention, reference will now be made to the embodiment illustrated in the drawings, and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect,” “another aspect,” or similar language means that a particular feature, structure, or characteristic described in connection with the embodiment is included in at least one embodiment of the present disclosure. Thus, appearances of the phrase “in an embodiment,” “in another embodiment,” and similar language throughout this specification may, but do not necessarily, all refer to the same embodiment.

The terms “comprises,” “comprising,” or any other variations thereof are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail concerning the accompanying drawings.

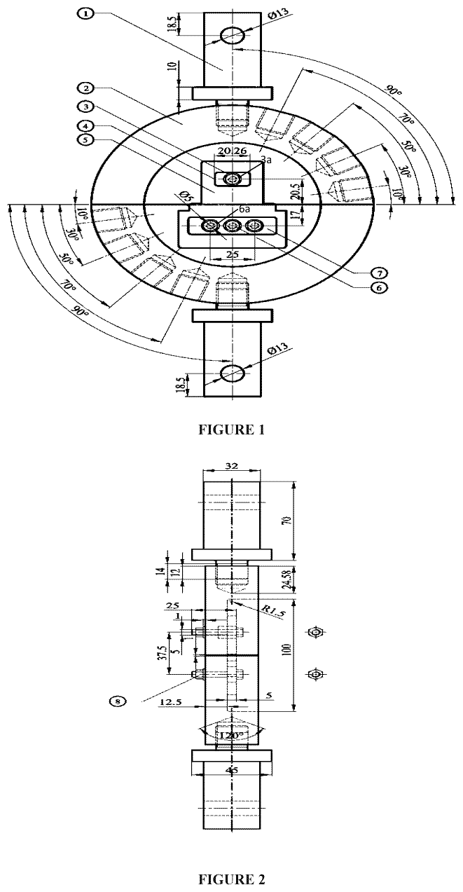

Referring to FIG. 1, an elevation view of the special fixtures is illustrated in accordance with an embodiment of the present disclosure. FIG. 1 shows the main components and dimensions of the fixtures and connection methods between all parts with different loading orientations.

The fixtures contain 8 parts connected by two pins and four bolts. The main aim of this type of connection is to simulate the actual loading and ensure accurate fixation during the loading time to provide good testing results. The proposed special fixtures comprise 17 loading angles for studying the most actual cases on the seat belt buckle by incrementing 5° degrees from 10° to 90° degrees.

The figure shows that the special fixtures comprise two connection pins (1) and four pairs of cylinder discs (2) with different loading angles. The first pair among the four pairs included 5 loading angles, and the other pairs had 4 loading angles with thread diameters equal to 18 mm for both pairs.

The connection between connection pin (1) and upper disc (2) is according to the threaded portion on the pin and threaded portion inside the upper and lower discs with thread diameter equal to M18. The pin has one through hole in the upper side with a diameter equal to 13 mm for connecting the pin with the universal tensile testing machine, wherein the hole includes a small clearance to permeate the connection pin inlet with an easy method.

The safety seat belt buckle (5) is fixed on the special fixture by two plates (4 and 7), wherein the plates (4 and 7) support and distribute the applied load inside the safety seat belt buckle (5) during the testing. The plates are fixed on the fixtures through four bolts (3a and 6a), wherein the bolt (3a) is fixed on the upper side, and the other three bolts (6a) are fixed on the lower side to fix the safety seat belt buckle with the plates during the testing without any slippage.

The key components visible are two connection pins (1) that securely hold the seat belt buckle in place during testing, four pairs of cylinder discs (2) with different angled surfaces to apply varied loading angles, and a base plate (4) on which the entire fixture assembly is mounted.

The parameters of safety in the universal safety seat belt buckle industry are one of the most important principal factors during the design and manufacturing processes for most seat belt buckle production companies. The product quality of safety seat belt buckles depends on the experimental mechanical testing method and fixation type used to simulate the actual load during loading. On the other hand, to increase the safety of the universal safety seat belt buckle, special fixtures (new mechanisms or fixtures) are required to simulate the orientation of the actual load and prevent slippage during the quality insurance tests of the product. Special fixtures (new mechanisms or fixtures) for testing the universal safety seat belt buckle consist of different parts to simulate the loading during the use of the product in several industrial applications. FIG. 1 shows the fixtures' main components, dimensions, and connection methods between parts with different loading orientations. The fixture consists of 8 parts connected based on two pins and four bolts. The main aim of this type of connection is to simulate the actual loading and ensure accurate fixation during the loading to give good testing results. The fixtures have seventeen loading angles (8) to study the most actual cases on the seat belt buckle by increment 5° degrees from 10° to 90°. On the other hand, the special fixtures consist of two connection pins No. 1 and four pairs of cylinder discs No. 2 with different loading angles. The first pairs included 5 loading angles; the other pairs had 4 loading angles with thread diameters equal to 18 mm for both pairs.

The connection between pin No. 1 and upper disc No. 2 is according to the threaded portion on the pin and the threaded portion inside the upper and lower discs with a thread diameter equal to M18. The pin has one through hole in the upper side with a diameter equal to 13 mm to connect the pin with the universal tensile testing machine. The hole has included a small clearance to permeate the connection pin inlet with an easy method. The safety seat belt buckle No. 5 is fixed on the special fixture No. 2 by two plates, No. 4 and 7. During the testing, the plates support and distribute the applied load inside the safety seat belt buckle No. 5. The plates are fixed on the fixtures by four bolts No. 3a and 6a. Bolt No. 3 is fixed on the upper side, and three bolts No. 6a on the lower side to fix the safety seat belt buckle with the plates during the testing without any slippage.

Referring to FIG. 2, a right-side view of the special fixtures is illustrated following an embodiment of the present disclosure. FIG. 2 shows a right-side view, highlighting the arrangement of the cylinder disc pairs (2) at different angles around the connection pins (1).

The fixture is designed to apply 17 different loading angles to the seat belt buckle, ranging from 10 to 90 degrees in 5-degree increments. This is achieved by having the top disc rotate in 5-degree steps relative to the middle disc, with each angular position corresponding to a specific load.

The angular load is applied via the pins extending down from the top disc and contacting the buckle. As the top disc rotates, the pins move through the different angular positions, creating the desired loading condition. This allows the full range of real-world crash scenarios to be simulated and the buckle's performance to be thoroughly evaluated.

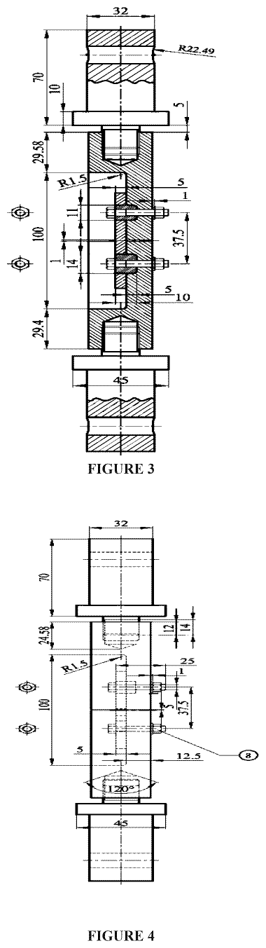

Referring to FIG. 3, a right sectional side view of the special fixtures is illustrated in accordance with an embodiment of the present disclosure. FIG. 3 is a cross-sectional side view including connection pins (1) passing through the center of the cylinder disc pairs (2). There are recesses (3, 6) in the base plate (4) that the cylinder discs fit into to maintain their angled orientation.

Referring to FIG. 4, a left-side view of the special fixtures is illustrated in accordance with an embodiment of the present disclosure. FIG. 4 shows the left-side view, again emphasizing the cylinder disc pairs (2) at various angles.

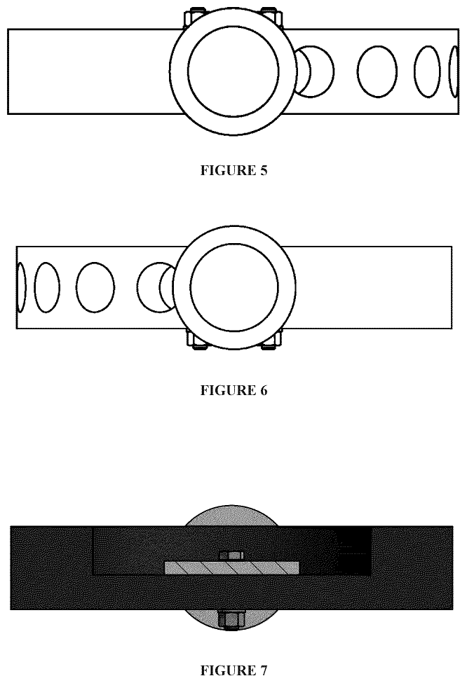

Referring to FIG. 5, a top view of the special fixtures is illustrated in accordance with an embodiment of the present disclosure. FIG. 5 is a top view, providing an overview of the full fixture setup with the cylinder discs (2) arranged around the central connection pins (1).

Referring to FIG. 6, a bottom view of the special fixtures is illustrated in accordance with an embodiment of the present disclosure. FIG. 6 is a bottom view of the base plate (4), showing the recesses (3, 6) that the cylinder discs (2) fit into.
1. The base disc—This provides the foundation for the fixture and allows it to be mounted securely.
2. The middle disc—This disc contains the slots and features that hold and position the seat belt buckle.
3. The top disc—This disc applies the angular loads to the buckle via a series of loading pins.

The three pieces work together to grip, position, and load the buckle in a controlled manner during testing.

A fixture disc is a key component in a device used to test the performance and durability of seat belt buckles. The main functions of the fixture disc are:
To securely hold and position the seat belt buckle being tested.
To apply controlled angular loads and forces to the buckle to simulate real-world conditions during a crash or emergency braking event.
To allow for precise adjustment and measurement of the loading angles applied to the buckle.

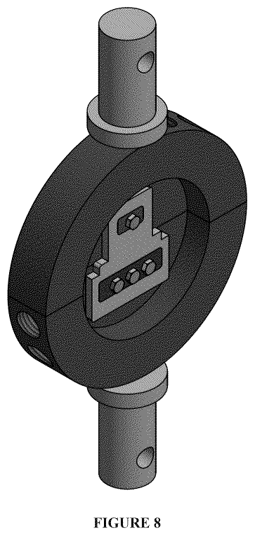

Referring to FIG. 7, a section button view of the special fixtures is illustrated in accordance with an embodiment of the present disclosure. FIG. 7 is a sectional button view, highlighting the secure connection between the base plate (4), connection pins (1), and cylinder discs (2).

The seat belt buckle is the key component being tested, as it needs to withstand significant forces during a crash or emergency braking event. The two plates in the fixture work in conjunction with the buckle to apply and measure the loads:
The base plate provides a stable foundation for the buckle to be mounted to.
The loading plate, which is the top disc, applies the angular forces to the buckle via the loading pins.
   The plates ensure the buckle is properly positioned and loaded in a controlled, measurable way to accurately assess its tensile strength and overall performance.

Referring to FIG. 8, a perspective view of the special fixtures is illustrated in accordance with an embodiment of the present disclosure. In an embodiment, the working of the special fixtures includes the turning operation is applied for pins (1) and both fixtures; the milling operation is used for both fixtures; the drilling operation is applied for pins (1) and both fixtures; polishing operation is applied for pins (1) and both fixtures; and coating nickel chrome operation for protection and covering is used for pins (1) and both fixtures.

The angles, length, and breadth are essential for simulating the actual applied load at different loading angles in industrial engineering applications. The angle is changed in accordance with the body size of the person and the type of application. Therefore, the special fixtures have covered all sizes and applications within the 17 angles.

In an embodiment, applied tensile stress (o) is calculated through the equation given below,

$$σ = \frac{F cos θ}{{A}_{o}} ( \frac{N}{{m}^{2}} ) N / {m}^{2}$$

Wherein in the above-given equation, F represents the applied tensile load (N), Aₒ represents the net cross-section area (m²), which is dependent on the main dimension of the seal belt buckle, and θ represents the loading angle in degree.

In an embodiment, the primary purpose of connection pins (1) is to link fixture disc (2) with the universal tensile testing machine during testing. The specific dimensions of these connection pins (1) depend on both the maximum loading capacity and the material type of the safety seat belt buckle. Conversely, the orientation of the safety seat belt buckle (5) varies during loading in real-world applications. This variability in loading direction is influenced by factors such as the individual's size and the application's nature utilizing the safety seat belt buckle. Consequently, fixture disc (2) is segmented into three pairs to accommodate all possible orientations of loading angles on the safety seat belt buckle for various applications.

The safety seat belt buckle holds paramount importance in ensuring human safety and finds application in various mechanisms, including:
Seat Belt Buckle of Parachutes
Seat Belt Buckle of Airships
Seat Belt Buckle for Car Drivers
Seat Belt Buckle for Airplane Passengers
Seat Belt Buckle for Firefighters
Seat Belt Buckle for Rescue Personnel

The versatile usage of seat belts across numerous engineering applications necessitates a design that can accommodate changes in loading orientation. Thus, the proposed design for testing the quality of safety seat belt buckles encompasses all loading orientations encountered across different engineering applications. This approach allows for comprehensive product quality assurance testing within a single test fixture, covering a range of applications with varying loading angles.

The present disclosure relates to specialized fixtures for tensile testing of universal safety seat belt buckles at different orientations. The proposed fixtures address the limitations of traditional testing methods by simulating a wide range of loading angles and orientations while ensuring secure fixation of the seat belt buckle during mechanical testing. The special fixtures can simulate seventeen different loading angles, ranging from 10 to 90 degrees with 5-degree increments, allowing for studying the most common and critical loading scenarios encountered by seat belt buckles in real-world situations. The fixtures incorporate two connection pins and four pairs of cylinder discs with different loading angles to prevent slippage and ensure accurate testing. By accurately replicating the diverse range of loading angles and orientations experienced by seat belt buckles, the proposed special fixtures enable manufacturers to understand the buckle's performance under various scenarios, which is crucial for identifying and addressing potential weaknesses or failure modes. This invention significantly improves traditional testing methods, providing manufacturers with a more accurate and reliable means of evaluating the performance and safety of universal safety seat belt buckles, ultimately contributing to the development of safer and more reliable automotive safety systems.

FIG. 9 illustrates a block diagram of a fixture system for tensile testing of a universal safety seat belt buckle in accordance with an embodiment of the present disclosure. The system 100 includes a base plate (4) adapted to mount on a fixture securely, the base plate comprising recesses (3, 6) configured to receive and position a plurality of cylinder discs (2) at predetermined loading angles.

In an embodiment, a plurality of connection pins (1) are adapted to link the fixture with a universal tensile testing machine and to securely hold the seat belt buckle (5) in place during testing, wherein the connection pins extending through the plurality of cylinder discs, wherein the connection pins have a threaded portion for secure attachment.

In an embodiment, a plurality of cylinder discs (2) are segmented into pairs, each pair having angled surfaces on an outer periphery thereof, the angled surfaces configured to apply the predetermined loading angles to the seat belt buckle (5) when the cylinder discs are positioned in the recesses (3, 6) of the base plate, wherein the plurality of cylinder discs comprise at least three pairs to accommodate a wide range of loading angles.

The plurality of cylinder discs is selectively positionable around the connection pins to simulate various loading angles on the seat belt buckle (5).

In another embodiment, the recesses (3, 6) of the base plate (4) include a V-shaped profile with an angle of 45 degrees, ensuring the cylinder discs (2) are centered accurately and resist lateral displacement during tensile force application, and wherein the outer surfaces of the cylinder discs (2) feature a concave curvature with a radius of 25 mm, designed to interface with the V-shaped recesses (3, 6) of the base plate (4) to enhance the mechanical lock and minimize rotational slippage under load.

In another embodiment, the predetermined loading angles range from 10 degrees to 90 degrees in 5-degree increments, wherein at least 17 loading angles ranging from 10 to 90 degrees, in 5-degree increments, are achieved by having 4 pairs of cylinder discs (2), wherein each pair of cylinder discs is machined with a specific angle selected from 10°, 15°, 20°, and 25° on their outer surfaces by positioning the different angled disc pairs around the central connection pins (1), the full range of 17 loading angles can be simulated.

In another embodiment, the plurality of cylinder discs comprises four pairs, each pair having a different predetermined loading angle, wherein each cylinder discs (2) is equipped with an angular alignment mechanism consisting of a series of notches spaced at 5-degree intervals along the outer edge, engaging with corresponding protrusions in the recesses (3, 6) to maintain precise angular positioning.

In another embodiment, the connection pins (1) and the cylinder discs (2) are manufactured from high-strength alloy steel, wherein the connection pins (1) pass through the center of the cylinder disc pairs (2), wherein the connection pins (1) are provided with a tapered shoulder at an interface with the cylinder discs (2), allowing for a gradual distribution of tensile forces across the disc surface, reducing stress concentrations at the disc bore, wherein said connection pins (1) incorporates a dual-start thread pattern, facilitating rapid engagement with the testing machine and incorporating a locking mechanism to prevent loosening under cyclic tensile loads.

In another embodiment, the system further comprises a nickel-chrome plating applied to the connection pins (1) and the cylinder discs (2) for corrosion resistance, and wherein central bore of each cylinder disc (2) is machined with a diameter tolerance of +0.01 mm, providing a precise fit with the connection pins (1) to ensure axial alignment and eliminate play between components during tensile testing.

In another embodiment, the recesses (3, 6) in the base plate (4) are configured to receive and position each pair of cylinder discs at a specific predetermined loading angle,

In another embodiment, the seat belt buckle (5) is securely positioned between the two connection pins (1), which prevents any slippage or movement during testing, wherein the cylinder discs (2) possess a dual-angle configuration, with one pair having a 10-degree offset and another having a 20-degree offset, allowing for a combined loading angle adjustment by stacking multiple disc pairs in a staggered arrangement.

In another embodiment, the system further comprises a locking plate (7) with an integrated load distribution grid, consisting of a series of ridges and grooves that align with the base plate (4), providing mechanical interlocking to stabilize the fixture under varying tensile loads.

In another embodiment, the locking plate (7) is adapted to support and distribute the applied load on the safety seat belt buckle during testing, wherein the plates (4, 7) are adapted to be fixed on the fixture, wherein the seat belt buckle (5) is clamped between two connection pins (1) that include a knurled surface along a pin shaft to enhance grip and prevent slippage during tensile force application.

In another embodiment, the connection pins (1) are equipped with anti-rotation flats on the sides of the shaft, interfacing with matching flat surfaces within the cylinder disc bores to prevent pin rotation relative to the discs during load application.

In another embodiment, at least four bolts (3a, 6a) are adapted to secure the plates to the fixture and fix the safety seat belt buckle between the plates during testing, wherein at least one bolt (3a) is positioned on an upper side of the fixture and at least three bolts (6a) are positioned on a lower side of the fixture, and wherein the bolts (3a, 6a) used to secure the base plate (4) and locking plate (7) are arranged in a triangular pattern, with each bolt having a countersunk head that fits into a corresponding countersink on the plates to ensure flush mounting and prevent rotational displacement.

In another embodiment, the cylinder discs (2) have a thread diameter of 18 mm, wherein the connection pins (1) include a through hole with a diameter of 13 mm for connection to the universal tensile testing machine, wherein the angled surfaces of the cylinder discs are adapted to cooperate with the plates to securely position the safety seat belt buckle (5) at the predetermined loading angle.

In another embodiment, the cylinder discs (2) are stackable in pairs, each pair featuring a unique key-and-slot mechanism that allows for secure vertical stacking and alignment, ensuring consistent force transmission through the stacked configuration.

In another embodiment, the seat belt buckle (5) is aligned using a pair of alignment guides positioned on either side of the buckle, these guides having a spring-loaded mechanism that exerts equal lateral pressure to maintain central alignment under tensile loads.

In another embodiment, the system further comprising integrated force sensors embedded within the locking plate (7) that measure the distribution of tensile forces across the seat belt buckle (5), providing real-time feedback on load application and ensuring accurate testing conditions, and wherein the load transfer from the cylinder discs (2) to the base plate (4) is optimized through a series of load transfer pads positioned between the discs and the plate, these pads having a compressive modulus calibrated to distribute forces evenly across the contact surfaces.

In another embodiment, the connection pins (1) are configured an internal stress relief channel that extends longitudinally through the pin body, allowing for the redistribution of stress concentrations away from the pin-thread interface and into the shaft body, thereby increasing the fatigue resistance of the pins during cyclic testing.

In another embodiment, the base plate (4) includes a calibration mechanism comprising a set of adjustable stops that interface with the cylinder discs (2) to calibrate the loading angles with an accuracy of ±0.05 degrees, allowing for precise tuning of the angular configurations during setup, and wherein the base plate (4) includes an array of M6 threaded holes, each spaced 20 mm apart, to enable precise attachment of the clamping mechanism.

In another embodiment, the system further comprising two linear guide rails positioned parallel to each other on the base plate (4), allowing for the adjustable positioning of the clamping jaws, and wherein the base plate (4) has a recessed channel running along its length to house electrical wiring for integrated sensors used during tensile testing.

In another embodiment, the system further comprising a pair of independently adjustable clamping jaws, each mounted on a dovetail slide, allowing for secure engagement with the universal safety seat belt buckle, wherein the base plate (4) includes a set of precision alignment pins that correspond to locating holes on the universal safety seat belt buckle, ensuring exact positioning during testing.

In an embodiment, the system comprising a quick-release mechanism integrated into the base plate (4), allowing for rapid attachment and detachment of the universal safety seat belt buckle without the need for tools, an integrated load cell mount on the base plate (4), positioned to directly measure the force applied to the universal safety seat belt buckle during tensile testing, wherein the base plate (4) features a grid of counterbore holes designed to accommodate socket head cap screws used for securing fixture components.

In another embodiment, the predetermined loading angles range from 10 degrees to 90 degrees in 5-degree increments, wherein at least 17 loading angles ranging from 10 to 90 degrees, in 5-degree increments, are achieved by having 4 pairs of cylinder discs (2), wherein each pair of cylinder discs is machined with a specific angle selected from 10°, 15°, 20°, and 25° on their outer surfaces by positioning the different angled disc pairs around the central connection pins (1), the full range of 17 loading angles can be simulated.

Yet, in another embodiment, the plurality of cylinder discs comprises four pairs, each pair having a different predetermined loading angle.

In a further embodiment, the connection pins (1) and the cylinder discs (2) are manufactured from high-strength alloy steel, wherein the connection pins (1) pass through the center of the cylinder disc pairs (2).

The system further comprises a nickel-chrome plating applied to the connection pins (1) and the cylinder discs (2) for corrosion resistance.

In another embodiment, the recesses (3, 6) in the base plate (4) are configured to receive and position each pair of cylinder discs at a specific predetermined loading angle.

In another embodiment, the seat belt buckle (5) is securely positioned between the two connection pins (1), which prevent any slippage or movement during testing.

In another embodiment, a locking plate is adapted to support and distribute the applied load on the safety seat belt buckle during testing, wherein the plates are adapted to be fixed on the fixture.

In another embodiment, at least four bolts are adapted to secure the plates to the fixture and fix the safety seat belt buckle between the plates during testing, wherein at least one bolt is positioned on the upper side of the fixture and at least three bolts are positioned on a lower side of the fixture.

In another embodiment, the cylinder discs (2) have a thread diameter of 18 mm, wherein the connection pins (1) include a through hole with a diameter of 13 mm for connection to the universal tensile testing machine, wherein the angled surfaces of the cylinder discs are adapted to cooperate with the plates to securely position the safety seat belt buckle (5) at the predetermined loading angle.

### Materials Used for the Fixture Components:

The connection pins (1), cylinder discs (2), and base plate (4) are all made of high-strength alloy steel to withstand the tensile loads during testing.
The components may also have a nickel-chrome plating for corrosion resistance and a smooth, durable surface finish.

### Distribution of the 17 Loading Angles:

Four pairs of cylinder discs (2) achieve the 17 loading angles ranging from 10 to 90 degrees, in 5-degree increments.
Each pair of cylinder discs is machined with a specific angle (e.g. 10°, 15°, 20°, 25°, etc.) on their outer surfaces.
By positioning the different angled disc pairs around the central connection pins (1), the full range of 17 loading angles can be simulated.

### Assembly and Disassembly Procedures:

The special fixtures are designed for easy assembly and disassembly to accommodate different seat belt buckle sizes and testing configurations.
Standard tools like wrenches and hex keys would be used to secure the connection pins (1) and attach/remove the cylinder disc pairs (2) from the base plate (4).
No specialized tools are required, but care must be taken to properly align and tighten all components to ensure the secure fixation of the seat belt buckle.

### Manufacturing Operations:

The connection pins (1), cylinder discs (2), and base plate (4) would all be manufactured using a combination of turning, milling, drilling, and polishing operations to achieve the required precise dimensions and smooth surfaces.
The turning operations would shape the cylindrical geometry of the connection pins and cylinder discs.
Milling would create the angled surfaces on the cylinder discs and the recesses in the base plate.
Drilling would make the holes for the connection pins to pass through.
Polishing would provide the final smooth, uniform finish on all components.
A nickel-chrome plating process may be applied at the end to enhance corrosion resistance and durability.

### Component Sizes and Ratios:

The overall size of the fixture assembly would depend on the dimensions of the specific seat belt buckle being tested.
However, the connection pins (1) are likely around 10-15 cm long and 1-2 cm in diameter to provide sufficient strength and stability.
The cylinder discs (2) would have a 5-10 cm diameter and a 2-4 cm thickness, with the angled surfaces machined to the appropriate 17 loading angles.

The base plate (4) would be sized to accommodate the cylinder disc pairs and provide a stable mounting surface, likely 20-30 cm on each side and 2-5 cm thick.
The specific size ratios between the components would be optimized through engineering analysis to ensure the fixtures can securely hold the seat belt buckle and withstand the tensile loads.

### Working of the Invention:

The special fixtures are designed to simulate a wide range of real-world loading conditions that a seat belt buckle may encounter during an accident or sudden stop event.
The seat belt buckle is securely positioned between the two connection pins (1), which prevents any slippage or movement during testing.
The four pairs of cylinder discs (2), each with a different angled surface, are arranged around the connection pins to apply the desired loading angle.
By selecting the appropriate pair of cylinder discs and positioning them correctly, the full range of 17 loading angles from 10 to 90 degrees, in 5-degree increments, can be tested.
This comprehensive testing across multiple loading angles allows manufacturers to thoroughly evaluate the seat belt buckle's performance and identify any potential failure modes or weaknesses in the design.
The secure fixation provided by the connection pins and angled cylinder discs ensures the test results accurately represent the buckle's behavior under realistic loading conditions, enabling the development of safer and more reliable automotive safety systems.

Certainly, here are some additional details about the special fixtures for tensile testing the universal safety seat belt buckle:

### Versatility and Adjustability:

The modular design of the fixtures allows for easy adaptation to accommodate different sizes and models of seat belt buckles.
The connection pins (1) can be adjusted in height to fit buckles of varying dimensions, ensuring a secure and customized hold.
The ability to swap out the cylinder disc pairs (2) with different angled surfaces provides the flexibility to test a wide range of loading conditions.

This versatility enables manufacturers to comprehensively evaluate their product line of safety seat belt buckles using the same fixture setup.

### Precision Engineering:

The fixtures are engineered with tight tolerances and high-quality materials to minimize any potential sources of error or inaccuracy during testing.
The cylinder discs (2) are precisely machined to ensure the specified angled surfaces are accurate to within fractions of a degree.
The recesses (3, 6) in the base plate (4) are carefully designed to properly locate and orient the cylinder disc pairs, maintaining the desired loading angles.
This attention to detail helps to eliminate any uncertainties or variations in the test results, providing reliable and reproducible data.

### Data Acquisition and Analysis:

The fixtures are designed to interface with advanced data acquisition systems, allowing for real-time monitoring and recording of the tensile testing process.
Sensors embedded within the connection pins (1) and base plate (4) can capture critical parameters such as applied force, displacement, and buckle deformation.
The collected data can then be analyzed to identify the specific loading conditions that result in buckle failure or performance degradation.
This meticulously compiled and comprehensive data set empowers manufacturers with the precision they need to make informed design improvements and validate the safety and reliability of their seat belt buckle products.

### Compliance and Standardization:

The special fixtures, meticulously engineered to meet and exceed industry standards and automotive safety component testing regulations, provide manufacturers with the reassurance of compliance.
By replicating real-world loading scenarios, the fixtures help manufacturers demonstrate the performance of their seat belt buckles in accordance with safety certifications and requirements.
The standardized testing methodology facilitated by these fixtures ensures consistency and comparability of results across different manufacturers, promoting overall quality and safety in the automotive industry.

Overall, the innovative design and engineering of these special fixtures for tensile testing of the universal safety seat belt buckle herald a significant advancement in automotive safety component evaluation. Thanks to this comprehensive and reliable testing platform, manufacturers can now develop and validate seat belt buckles that offer enhanced protection for vehicle occupants in a collision or emergency.

The working process/process of the invention vis a vis each of the components.
1. Turning Operation (Process): is applied for pins and both fixtures,
2. Milling Operation (Process): is applied for both fixtures,
3. Drilling Operation (Process): is applied for pins and both fixtures,
4. Polishing Operation (Process): is applied for pins and both fixtures,
5. Coating Nickel Chrome Operation (Protection Process, Covering Material): is applied for pins and both fixtures.

The specifications—angles and length/breadth—are very important in order to simulate the actual applied load at different loading angles in industrial engineering applications. On the other hand, the angle is changed according to the person's body size and type of application. Therefore, the fixtures covered all sizes and applications from 17 angles.

The developed safety seat belt buckle is one of the most important parts of safety for humans and is applied in several mechanisms such as:
Seat Belt Buckle of Parachute,
Seat Belt Buckle of Airship,
Seat Belt Buckle of the car driver,
Seat Belt Buckle of Airplane passenger,
Seat Belt Buckle of the fireman,
Seat Belt Buckle of the rescue man,

The multi-use of the seat belt in many engineering applications leads to a change in the loading orientation. Therefore, the suggested design for testing the quality of safety seat belt buckles covers all the loading orientations with different engineering applications. The variety of orientations for the loading angles permits the quality assurance tests of the product with higher quality in one test fixture with different applications.

The principal aim of the two connection pins No. 1 is to connect fixture disc No. 2 with the universal tensile testing machine during the testing. The main dimensions of connection pin No. 1 depend on the maximum loading capacity and the material type of safety seat belt buckle. On the other hand, the orientation of the safety seat belt buckle No. 5 is not constant during the loading in the application, but the loading direction is variable according to the person's size and the nature of the application that used the safety seat belt buckle. Therefore, the design of fixture disc No. 2 is divided into three different pairs to cover all the orientations of loading angles on the safety seat belt buckle for different applications.

Fixture Discs and their Functions:
Fixture Discs are Crucial Components that:
Securely hold and position the seat belt buckle during testing.
Apply controlled, angled loads and forces to simulate real-world crash scenarios.
Allow for precise adjustment and measurement of the loading angles.

### Segmented Fixture Discs:

### The Fixture Might Utilize Three Segmented Discs:

Base Disc: Provides a stable foundation for mounting the fixture.
Middle Disc: Contains features that hold and position the seat belt buckle.
Top Disc (Loading Plate): Applies angular loads through loading pins.

These segments work together to grip, position, and load the buckle precisely for testing.

### 17 Loading Angles:

The fixture offers 17 distinct loading angles (10° to 90° in 5° increments) to simulate various crash scenarios. The top disc likely rotates in 5-degree steps relative to the middle disc, with each position corresponding to a specific load applied via pins to the buckle.

### Safety Seat Belt Buckle and Plates:

The seat belt buckle is the component under test, needing to withstand significant forces during crashes.

### Two Plates Play Crucial Roles:

Base Plate: Provides a stable foundation for mounting the buckle.
Loading Plate (Top Disc): Applies angular forces via loading pins.

These plates ensure proper positioning and controlled, measurable loading to assess the buckle's performance accurately.

### Testing Tensile Strength:

The buckle is secured in the fixture.
A force gauge (connected to the loading plate) applies a steadily increasing load.
The increasing force is measured and recorded as the loading plate rotates.
Testing continues until the buckle reaches its failure point.

The fixture allows testing at various loading angles, providing comprehensive data on the buckle's tensile strength and overall performance, ensuring its ability to withstand crash forces.

### Video and Additional Discs:

Unfortunately, I cannot directly share videos, but you can likely find relevant ones online.

The “four pairs of cylindrical discs with different loading angles” might be supplementary components for creating more complex loading scenarios beyond the standard 17 angles. These discs would likely offer alternative angles to simulate a wider range of real-world crash dynamics and seat belt usage conditions.

### Manufacturing Operations:

Turning: Shapes and sizes pins and disc surfaces.
Milling: Creates specific features and mounting points on the discs.
Drilling: Enables angled pin holes in the discs.
Polishing: Provides a smooth finish for component interaction.
Nickel Chrome Coating: Adds a protective layer for corrosion resistance.

To test the tensile strength of the seat belt, the fixture applies a steadily increasing load to the buckle until it reaches the point of failure. This uses a force gauge or load cell connected to the plate. The increasing force is measured and recorded as the plate rotates and the pins push against the buckle.

The fixture allows the full range of real-world loading angles to be tested, providing comprehensive data on the buckle's tensile capabilities. This helps ensure that the seat belt system can withstand the extreme forces encountered in a crash scenario.

The “four pairs of cylindrical discs with different loading angles” refer to additional fixture components that can be used to apply more complex loading conditions. These are likely supplementary discs that can be swapped to create alternative loading scenarios beyond the standard 17-angle setup.

The different loading angles on these supplementary discs allow the fixture to simulate a wider range of real-world crash dynamics and seat belt usage conditions.

The various manufacturing operations applied to the fixture components help ensure precision, durability, and proper function:
Turning-Used to shape and size the pins and disc surfaces.
Milling-Utilized to create the specific features and mounting points on the discs.
Drilling-Enables the creation of the angled pin holes in the discs.
Polishing-Provides a smooth, consistent finish on the components.
Nickel chrome coating-Adds a protective layer to improve corrosion resistance and longevity.

The ability to perform all these specialized manufacturing steps within the fixture design allows it to be a high-precision, rugged testing platform capable of accurately simulating real-world seat belt performance.

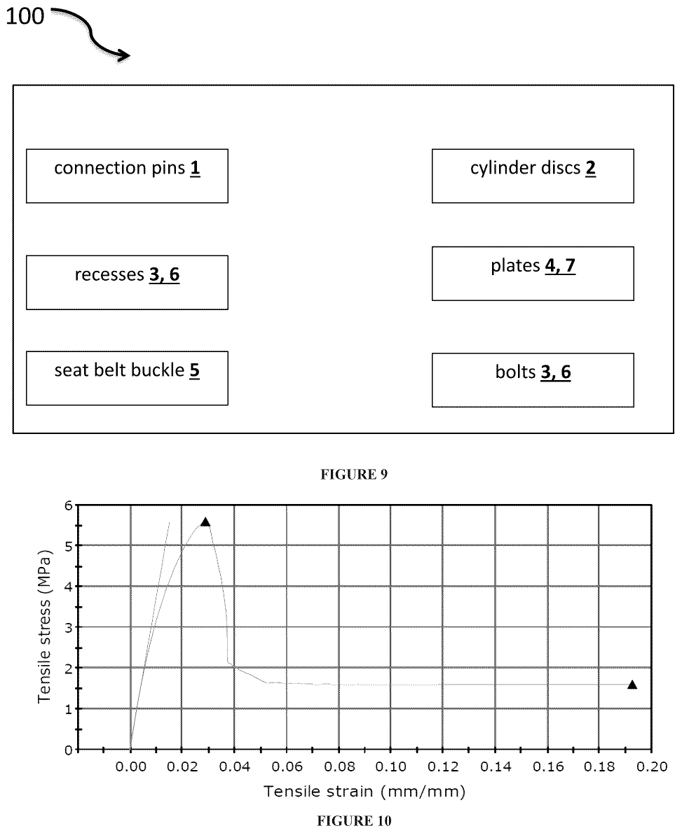

FIG. 10 illustrates a graph depicting tensile testing performed according to the ASTM D 638 standard 10-degree angle in accordance with an embodiment of the present disclosure.

The tensile testing was performed according to the ASTM D 638 standard.

The specimen number is 1.

The graph shows the specimen's Tensile Stress (in MPa) plotted against Tensile Strain (in mm/mm).

### The Key Tensile Properties Reported for the Specimen Include:

Maximum Load: 1118.32604 N
Tensile Stress at Maximum Load: 5.59163 MPa
Extension at Maximum Load: 2.01687 mm
Tensile Strain at Maximum Load: 0.02881 mm/mm
Modulus (Automatic): 367.58280 MPa
Tensile Strain at Yield (Zero Slope): 0.02881 mm/mm
Tensile Stress at Yield (Zero Slope): 5.59163 MPa
Tensile Strain at Break (Standard): 0.19234 mm/mm
Tensile Stress at Break (Standard): 1.61093 MPa
Extension at Break (Standard): 13.46381 mm
Energy at Maximum Load: 1.47953 J
Load at Break (Standard): 322.18613 N

In summary, this document reports the results of a tensile test performed on a single specimen at a 10-degree angle and provides the key mechanical properties derived from the test.

The tensile test was performed to characterize the mechanical behavior of the material under uniaxial tension. The specimen was loaded along the 10-degree orientation, which means the loading direction was aligned with the 10-degree axis of the material.

The stress-strain curve shown in the graph shows the material's typical tensile response. The curve starts linearly, indicating an elastic deformation regime where the material behaves reversibly, likely spring-like. The slope of this linear region gives the material's tensile modulus, which was measured as 367.58 MPa.

As the strain increases, the curve transitions to a nonlinear regime, indicating plastic deformation of the material. The maximum stress reached during the test was 5.59 MPa, corresponding to the material's tensile strength. At this point, the strain was measured as 0.0288 mm/mm.

Beyond the maximum load, the stress decreased as the specimen continued to deform. The strain at the point of fracture or break was 0.1923 mm/mm, and the corresponding stress was 1.61 MPa. The total extension of the specimen at break was 13.46 mm.

Additionally, the report provides other metrics, such as the load and energy absorbed at maximum load, which can be useful for understanding the material's behavior and potential applications.

Overall, this tensile test at the 10-degree orientation provides valuable characterization of the material's mechanical properties, including its stiffness, strength, and ductility. This information can be used to design, analyze, and optimize components made from this material.

FIG. 11 illustrates a graph depicting tensile testing performed according to the ASTM D 638 standard 50-degree angle in accordance with an embodiment of the present disclosure.

The tensile testing strictly adhered to the universally recognized ASTM D 638 standard, ensuring the reliability and comparability of our results.

The graph shows the Tensile Stress (in MPa) plotted against Tensile Strain (in mm/mm) for the two specimens.

The key tensile properties reported for the two specimens include the Specimen
Maximum Load: 1262.55 N
Tensile Stress at Maximum Load: 6.31 MPa
Extension at Maximum Load: 3.06 mm
Tensile Strain at Maximum Load: 0.0437 mm/mm
Modulus (Automatic): 331.00 MPa
Tensile Strain at Yield (Zero Slope): 0.0437 mm/mm
Tensile Stress at Yield (Zero Slope): 6.31 MPa
Tensile Strain at Break (Standard): 0.0528 mm/mm
Tensile Stress at Break (Standard): 3.83 MPa
Extension at Break (Standard): 3.69 mm
Energy at Maximum Load: 2.79 J
Load at Break (Standard): 765.74 N

### Specimen 2:

Maximum Load: 388.62 N
Tensile Stress at Maximum Load: 1.94 MPa
Extension at Maximum Load: 4.07 mm
Tensile Strain at Maximum Load: 0.0581 mm/mm
Modulus (Automatic): 360.67 MPa
Tensile Strain at Break (Standard): 0.0637 mm/mm
Tensile Stress at Break (Standard): 1.49 MPa
Extension at Break (Standard): 4.46 mm
Energy at Maximum Load: 0.13 J
Load at Break (Standard): 298.72 N

The report goes beyond the raw data and delves into a comprehensive analysis of the test results, including the mean, median, minimum, maximum, and coefficient of variation for the various tensile properties, offering a deeper understanding of the material's behavior.

In summary, this document presents the results of tensile testing of two buckle specimens at a 50-degree angle, providing detailed information on the mechanical behavior and properties of the material in this orientation.

Tensile testing was conducted according to the ASTM D 638 standard, a standard test method for the tensile properties of plastics.

This standard specifies the specimen geometry, test setup, and procedures for determining various tensile properties.

Testing at a 50-degree angle is a common practice to evaluate the anisotropic behavior of materials, as the properties can vary based on the loading direction relative to the material's orientation.

The stress-strain curves for the two specimens show distinct differences in their mechanical response.

Specimen 1 exhibits a more linear, elastic behavior up to the maximum load, followed by a gradual decline in stress.

Specimen 2, on the other hand, shows a more nonlinear stress-strain relationship, with a lower maximum stress but larger deformation at failure.

The maximum tensile stress for Specimen 1 is significantly higher than Specimen 2 (6.31 MPa vs. 1.94 MPa), indicating a much stronger material response in this orientation.

However, Specimen 2 exhibits a higher tensile strain at maximum load (0.0581 mm/mm vs. 0.0437 mm/mm) and a higher tensile strain at break (0.0637 mm/mm vs. 0.0528 mm/mm), suggesting a more ductile behavior.

The modulus values are also quite different, with Specimen 2 having a higher modulus of 360.67 MPa compared to 331.00 MPa for Specimen 1, indicating a stiffer material response.

The statistical analysis provides insights into the variability of the test results.

The high coefficient of variation (around 75%) for several properties, such as maximum load and tensile stress at maximum load, suggests a significant degree of variability between the two specimens.

This variability could be due to material inhomogeneity, manufacturing defects, or testing inconsistencies.

The tensile properties obtained at the 50-degree angle can be useful in understanding the performance and design considerations for components or structures that may experience loading in this orientation, such as in certain aerospace, automotive, or sports equipment applications.

The data can also be used for material modeling, finite element analysis, and predicting the material's behavior under similar loading conditions.

In summary, the tensile testing results presented in this document provide a detailed characterization of the mechanical behavior of the buckle specimens tested at a 50-degree angle, highlighting the material's anisotropic nature and variability in its tensile properties.

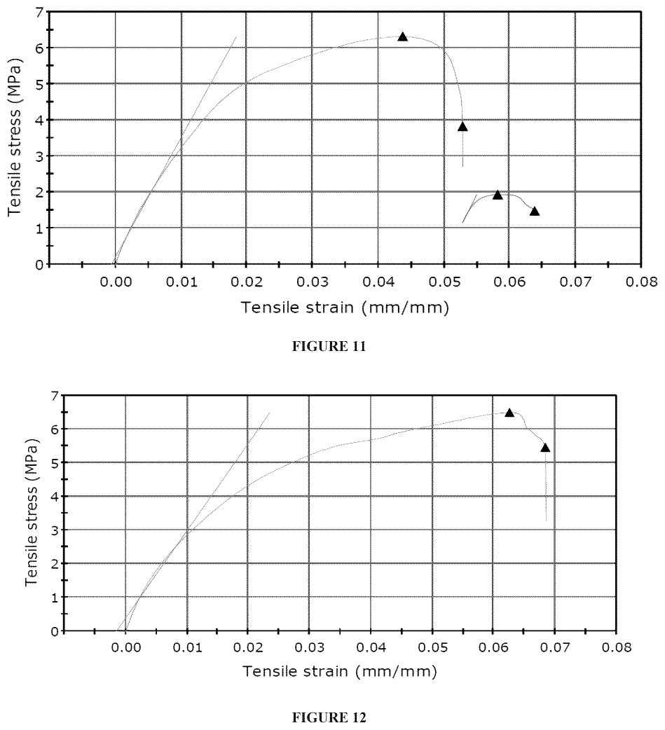

FIG. 12 illustrates a graph depicting tensile testing performed according to the ASTM D 638 standard 90-degree angle in accordance with an embodiment of the present disclosure.

Based on the figure above provided here is a description of the buckle specimen tensile testing conducted at a 90-degree angle:

Tensile testing was performed according to the ASTM D 638 standard, a standard test method for determining the tensile properties of plastics.

The testing was conducted on a single specimen labeled as Specimen 1.

The specimen's stress-strain curve shows a linear, elastic response up to the maximum load, followed by a gradual decline in stress.

The behavior suggests a relatively stiff and brittle material response in this loading orientation.

The maximum tensile stress recorded for the specimen is 6.49 MPa.

The tensile strain at maximum load is 0.0625 mm/mm, and the tensile strain at break is 0.0683 mm/mm.

The modulus of the material, calculated automatically, is 259.01 MPa, indicating a relatively high stiffness.

Since only one specimen was tested, no statistical analysis or comparison between multiple specimens is provided.

The results represent the performance of the one tested specimen at the 90-degree loading angle.

The tensile properties obtained at the 90-degree angle can be useful in understanding the performance and design considerations for components or structures that may experience loading in this orientation, such as in certain structural or engineering applications.

The data can also be used for material modeling, finite element analysis, and predicting the material's behavior under similar loading conditions.

In summary, the tensile testing results presented in the document provide detailed information about the mechanical behavior of the buckle specimen tested at a 90-degree angle, highlighting the stiffness and brittleness of the material response in this loading direction.

The drawings and the forgoing description give examples of embodiments. Those skilled in the art will appreciate that one or more of the described elements may be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown, nor do all of the acts necessarily need to be performed. Also, those acts that are not dependent on other acts may be performed in parallel with the others. The scope of embodiments is by no means limited by these specific examples. Numerous variations, whether explicitly given in the specification or not, such as differences in structure, dimension, and use of material, are possible. The scope of embodiments is at least as broad as the following claims.

Benefits, other advantages, and solutions to problems have been described above in terms of specific embodiments. However, the benefits, advantages, solutions to problems, and any component(s) that may cause any benefit, advantage, or solution to occur or become more pronounced are not to be construed as a critical, required, or essential feature or component of any or all the claims.

1. A fixture system for tensile testing of a universal safety seat belt buckle, the system comprises:
a base plate adapted to mount on a fixture securely, the base plate comprising recesses configured to receive and position a plurality of cylinder discs at predetermined loading angles;
a plurality of connection pins adapted to link the fixture with a universal tensile testing machine and to securely hold the seat belt buckle in place during testing, wherein the connection pins extend through the plurality of cylinder discs, wherein the connection pins have a threaded portion for secure attachment;
a plurality of cylinder discs segmented into pairs, each pair having angled surfaces on an outer periphery thereof, the angled surfaces configured to apply the predetermined loading angles to the seat belt buckle when the cylinder discs are positioned in the recesses of the base plate, wherein the plurality of cylinder discs comprise at least three pairs to accommodate a wide range of loading angles; and
wherein the plurality of cylinder discs are selectively positionable around the connection pins to simulate various loading angles on the seat belt buckle, and wherein the recesses are configured to align the cylinder discs with an angular deviation of less than 0.5 degrees from the intended loading path, wherein the recesses of the base plate include a V-shaped profile with an angle of 45 degrees, ensuring the cylinder discs are centered accurately and resist lateral displacement during tensile force application, and wherein the outer surfaces of the cylinder discs feature a concave curvature with a radius of 25 mm, to interface with the V-shaped recesses of the base plate.

2. The system of claim 1, wherein the predetermined loading angles range from 10 degrees to 90 degrees in 5-degree increments, wherein at least 17 loading angles ranging from 10 to 90 degrees, in 5-degree increments, configured by having 4 pairs of cylinder discs, wherein each pair of cylinder discs is machined with a specific angle selected from 10°, 15°, 20°, and 25° on their outer surfaces by positioning the different angled disc pairs around the central connection pins, the full range of 17 loading angles can be simulated.

3. The system of claim 2, wherein the plurality of cylinder discs comprises four pairs, each pair having a different predetermined loading angle, wherein each cylinder discs is equipped with an angular alignment mechanism consisting of a series of notches spaced at 5-degree intervals along the outer edge, engaging with corresponding protrusions in the recesses to maintain precise angular positioning.

4. The system of claim 1, wherein the connection pins and the cylinder discs are manufactured from high-strength alloy steel, wherein the connection pins pass through the center of the cylinder disc pairs, wherein the connection pins are provided with a tapered shoulder at an interface with the cylinder discs, allowing for a gradual distribution of tensile forces across the disc surface, reducing stress concentrations at the disc bore, wherein said connection pins incorporates a dual-start thread pattern, facilitating rapid engagement with the testing machine and incorporating a locking mechanism to prevent loosening under cyclic tensile loads.

5. The system of claim 4, further comprises a nickel-chrome plating applied to the connection pins and the cylinder discs for corrosion resistance, and wherein central bore of each cylinder disc is machined with a diameter tolerance of +0.01 mm, providing a precise fit with the connection pins to ensure axial alignment and eliminate play between components during tensile testing.

6. The system of claim 1, wherein the recesses in the base plate are configured to receive and position each pair of cylinder discs at a specific predetermined loading angle.

7. The system of claim 1, wherein the seat belt buckle is securely positioned between the two connection pins, which prevent any slippage or movement during testing, wherein the cylinder discs possess a dual-angle configuration, with one pair having a 10-degree offset and another having a 20-degree offset, allowing for a combined loading angle adjustment by stacking multiple disc pairs in a staggered arrangement.

8. The system of claim 1, further comprising a locking plate with an integrated load distribution grid, consisting of a series of ridges and grooves that align with the base plate, providing mechanical interlocking to stabilize the fixture under varying tensile loads.

9. The system of claim 8, wherein the locking plate is adapted to support and distribute the applied load on the safety seat belt buckle during testing, wherein the plates are adapted to be fixed on the fixture, wherein the seat belt buckle is clamped between two connection pins that include a knurled surface along a pin shaft to enhance grip and prevent slippage during tensile force application.

10. The system of claim 8, wherein the connection pins are equipped with anti-rotation flats on the sides of the shaft, interfacing with matching flat surfaces within the cylinder disc bores to prevent pin rotation relative to the discs during load application.

11. The system of claim 1, wherein at least four bolts are adapted to secure the plates to the fixture and fix the safety seat belt buckle between the plates during testing, wherein at least one bolt is positioned on an upper side of the fixture and at least three bolts are positioned on a lower side of the fixture, and wherein the bolts used to secure the base plate and locking plate are arranged in a triangular pattern, with each bolt having a countersunk head that fits into a corresponding countersink on the plates to ensure flush mounting and prevent rotational displacement.

12. The system of claim 1, wherein the cylinder discs have a thread diameter of 18 mm, wherein the connection pins include a through hole with a diameter of 13 mm for connection to the universal tensile testing machine, wherein the angled surfaces of the cylinder discs are adapted to cooperate with the plates to securely position the safety seat belt buckle at the predetermined loading angle.

13. The system of claim 7, wherein the cylinder discs are stackable in pairs, each pair featuring a unique key-and-slot mechanism that allows for secure vertical stacking and alignment, ensuring consistent force transmission through the stacked configuration.

14. The system of claim 7, wherein the seat belt buckle is aligned using a pair of alignment guides positioned on either side of the buckle, these guides having a spring-loaded mechanism that exerts equal lateral pressure to maintain central alignment under tensile loads.

15. The system of claim 7, further comprising integrated force sensors embedded within the locking plate that measure the distribution of tensile forces across the seat belt buckle, providing real-time feedback on load application and ensuring accurate testing conditions, and wherein the load transfer from the cylinder discs to the base plate is optimized through a series of load transfer pads positioned between the discs and the plate, these pads having a compressive modulus calibrated to distribute forces evenly across the contact surfaces.

16. The system of claim 1, wherein the connection pins are configured an internal stress relief channel that extends longitudinally through the pin body, allowing for the redistribution of stress concentrations away from the pin-thread interface and into the shaft body, thereby increasing the fatigue resistance of the pins during cyclic testing.

17. The system of claim 1, wherein the base plate includes a calibration mechanism comprising a set of adjustable stops that interface with the cylinder discs to calibrate the loading angles with an accuracy of ±0.05 degrees, allowing for precise tuning of the angular configurations during setup, and wherein the base plate includes an array of M6 threaded holes, each spaced 20 mm apart, to enable precise attachment of the clamping mechanism.

18. The system of claim 1, further comprising two linear guide rails positioned parallel to each other on the base plate, allowing for the adjustable positioning of the clamping jaws, and wherein the base plate has a recessed channel running along its length to house electrical wiring for integrated sensors used during tensile testing.

19. The system of claim 1, further comprising a pair of independently adjustable clamping jaws, each mounted on a dovetail slide, allowing for secure engagement with the universal safety seat belt buckle, wherein the base plate includes a set of precision alignment pins that correspond to locating holes on the universal safety seat belt buckle, ensuring exact positioning during testing.

20. The system of claim 1, further comprising a quick-release mechanism integrated into the base plate, allowing for rapid attachment and detachment of the universal safety seat belt buckle without the need for tools, and an integrated load cell mount on the base plate, positioned to directly measure the force applied to the universal safety seat belt buckle during tensile testing, wherein the base plate features a grid of counterbore holes to accommodate socket head cap screws used for securing fixture components.
